(19) United States
(12) Patent Application Publication
(10) Pub. No.: US 2014/0262184 A1
(43) Pub. Date: Sep. 18, 2014

(54) METHOD AND APPARATUS FOR SECURING TWO COMPONENTS FOR BRAZING

(71) Applicant: CALSONICKANSEI NORTH AMERICA, INC., Farmington Hills, MI (US)

(72) Inventors: James Dean Snow, Novi, MI (US); William Tracey Guffey, Shelbyville, TN (US)

(73) Assignee: CALSONICKANSEI NORTH AMERICA, INC., Farmington Hills, MI (US)

(21) Appl. No.: 13/828,448

(22) Filed: Mar. 14, 2013

(51) Int. Cl. B23K 1/00

(52) U.S. Cl. CPC B23K 1/0012
USPC 165/177; 228/246; 228/136

(57) ABSTRACT

Two components necessary to make up a heat exchanger assembly generally need to be brazed. Two components may be secured which do not contain a cladded alloy. Staking or crimping is used to hold the two components together while securing a braze ring captured between the two components which acts as a brazing mechanism.

### TECHNICAL FIELD OF THE INVENTION

This invention relates generally to a method for securing two components. More specifically, the invention relates to a method for securing two components for a brazing process, particularly aluminum components.

### BACKGROUND OF THE INVENTION

A heat exchanger is a device which transfers the heat of one substance to another, for example, from a warm or hot surface to a cold or cooler one. Heat exchangers are widely used in industrial processing plants, power plants, air conditioning, vehicles, and the like as evaporators, condensers, and radiators. In a simple form, a heat exchanger includes one or more passages through which a fluid flows while exchanging heat with the environment surrounding the passages.

Heat exchangers, particularly automotive radiators, often consist of a composite structure including tanks of a reinforced plastic attached to an aluminum core by crimping with gasket seals between the components. An all aluminum heat exchanger, e.g., an entire radiator including the tanks, is advantageous to provide packaging advantages and recycling advantages with smaller tank width by eliminating the header crimp area between the core and the tanks. Some components that are to be joined together are joined by brazing, wherein at least one component to be brazed contains a clad alloy to ensure proper brazing between two or more components.

### BRIEF DESCRIPTION OF THE DRAWINGS

FIG. 1 is a is a cross sectional view of a tubing member and extrusion arrangement prior to staking in accordance with an embodiment;

FIG. 2A is a top view showing the staking of the tubing member within the extrusion member in an embodiment of FIG. 1;

FIG. 2B is a cross sectional view showing the staking of the tubing member within the extrusion member in an embodiment of FIG. 1;

FIG. 3 is a cross sectional view of a further embodiment of a tubing member and extrusion member arrangement prior to securing the tubing member to the extrusion member;

FIG. 4 is a plan view of the extrusion member showing an annular groove in an embodiment of FIG. 3;

FIG. 5 is a cross sectional view of the extrusion member after crimping in an embodiment of FIG. 3;

FIG. 6 shows a flowchart of a method of securing two components in accordance with an embodiment; and

FIG. 7 shows a flowchart of a method of securing two components in accordance with another embodiment.

### DETAILED DESCRIPTION OF THE INVENTION

In the present invention, a braze ring and a method to secure two components is used. This invention provides a braze ring in between two components, which is secured by a staking or crimping method.

Accordingly, the present invention relates to a heat exchanger assembly comprising an extrusion member; a tubing member; a brazing ring; and a securing area provided in a surface of the extrusion member in order to secure the tubing member to the extrusion member.

The present invention further relates to a method of securing two components comprising: securing a brazing ring between a first component and a second component; securing a surface area of the first component in order to secure the first and the second components together; and brazing the braze ring.

This invention solves the problem of having to add a clad alloy to at least one of two components to be brazed. Adding a clad alloy requires additional manufacturing steps and costs to the process. Furthermore, this invention makes possible for two components to be brazed and not require a clad alloy in either component but rather a braze ring between two components and a method to secure the two components.

This invention demonstrates how to secure two components, which do not contain a clad alloy, in order to prepare for the brazing process. This invention involves a staking or crimping method to hold the two components together, all the while securing a braze ring that is captured in between the two components to act as the brazing mechanism.

FIG. 1 is a cross sectional view of a tubing member 10 and an extrusion member 14 arrangement prior to securing the components together. A braze ring 12 is mounted on tubing member 10. A bead 13 is may be formed in a rolling process on tubing member 10 and can thus be part of tubing member 10 itself. Tubing member 10 is mounted in an extrusion member 14. Braze ring 12 is provided below bead 13 and abuts against both a step down portion 18 provided in a bore 19 of extrusion member 14 and bead 13. See FIG. 2. This provides a sandwich arrangement between bead 13, braze ring 12 and step down portion 18 for enhanced securement of the tubing member 10 within the extrusion member 14 when performing the brazing operation.

Aluminum tubing (no clad alloy) may be used for tubing member 10. Aluminum extrusion (no clad alloy) may be used for extrusion member 14. A clad alloy is a metal to which a metal coasting has been applied. This coating often provides an improved wearing surface, a better appearance, or corrosion protection. The clad alloy also allows for other clad alloy components to be brazed together.

FIG. 2 is a cross sectional view showing a securing area 15 of extrusion member 14 in a secured configuration against bead 13 of tubing member 10. Securing area 15 is provided in an upper surface of extrusion member 14 in order to secure tubing member 10 to step down portion 18 in bore 19 of extrusion member 14. Securing area 15 being placed in a secured configuration against bead 13 of tubing 10 securely holds braze ring 12 between bead 13 and step down portion 18 during a brazing process. The secured configuration of securing area 15 may be staking of the securing area 15. This prevents unwanted rotation of tubing member 10 with respect to extrusion member 14 during the brazing process. Staking generally includes forming a staking hole 20 to create a securing member 22, wherein securing member 22 is moved to engage bead 13 and secure braze ring 12 between bead 13 and step down portion 18.

FIG. 3 is a cross-sectional view of a further embodiment for mounting the extrusion member 14 on tubing member 10. The extrusion member 14 is provided with an annular groove 16 provided on the extrusion member 14. The annular groove 16 is machined within an upper surface 17 of the extrusion member 14 in order to provide securing ring 11, as also shown in FIGS. 4 and 5. Braze ring 12 is mounted on tubing member 10. Bead 13 is typically formed in a rolling process on the tubing member 10 and is part of tubing member 10 itself. The tubing member 10 is mounted in extrusion member 14 to perform a brazing process.

FIG. 4 is a plan view of extrusion member 14 showing annular groove 16. Annular groove 16 is shown formed in extrusion member 14 by machining. It will be understood that other ways of forming annular groove may be employed so long as annular groove 16 is formed to create securing ring 11.

FIG. 5 is a cross sectional view of extrusion member 14 receiving tubing member 10 after crimping of securing ring 11 formed by annular groove 16. Crimping of securing ring 11 is a process in which securing ring 11 is crimped or moved to engage bead 13. In a crimping process, top end of securing ring 11 is moved radially toward an axis of the ring to engage bead 13.

According to particular embodiments shown in FIGS. 3-5, bead 13 within extrusion member 14 enables for crimping to secure tubing member 10 within extrusion member 14. Braze ring 12 is provided below bead 13 and abuts against both a step down portion 18 provided in a bore 19 of extrusion member 14 and bead 13. This provides a sandwich arrangement between bead 13, braze ring 12 and step down portion 18 for enhanced securement of tubing member 10 within extrusion member 14 when performing the brazing operation.

Annular groove 16 on upper surface 17 of extrusion member 14 is radially displaced in direction 30 from a center of step down portion 18 along bore 19 within the extrusion member 14 and forms securing ring 11. Crimping of securing ring 11 is provided in upper surface 17 of extrusion member 14 in order to secure tubing member 10 to step down portion 18 in bore 19 of extrusion member 14. Performing crimping of securing ring 11 against bead 13 of tubing 10 securely holds braze ring 12 between bead 13 and step down portion 18 during a brazing process. This crimping prevents unwanted rotation of tubing member 10 with respect to extrusion member 14 during the brazing process.

Two components necessary to make a heat exchanger assembly may be brazed by any known method, such as controlled atmospheric brazing (CAB). CAB is generally brazing in a dry, inert gas atmosphere. Various inert gases may be utilized in the CAB process, such as, but not limited to nitrogen, argon, helium and the like.

FIG. 6 shows a flowchart of a method of securing two components in accordance with the present invention. Process 60 provides a generalized methodology of the operations involved in securing two components, tubing member 10 and extrusion member 14 as shown in FIGS. 1 and 2. Process 60 begin with operation 62. At operation 62, a braze ring 12 is retained between the two component. Further at operation 62, bead portion 13 of second component (tubing member 10) may be abutted against braze ring 12.

Process 60 continues with an operation 64. At operation 64, a first component is secured against a second component. Further, operation 64 may further include operating a staking tool to stake securing area 15 second component. Operation 64 may further include engaging securing area 15 with bead 13 to secure tubing member 10 of the second component within extrusion member 14 of the first component. Operation 64 may further include sandwiching braze ring 12 between bead 13 and step down portion 18 of bore 19 in response to staking of securing area 15.

According to process 60, operation 64 may then be followed by operation 66 of brazing the braze ring 12. At operation 66, brazing the braze ring may include controlled atmosphere brazing.

FIG. 7 shows a flowchart of a method of securing two components in accordance with another embodiment of the present invention. Process 70 provides a generalized methodology of the operations involved in securing two components, tubing member 10 and extrusion member 14, as shown in FIGS. 3-5. Process 70 begins at operation 72. At operation 72, machining a groove 16 in the first component to form a securing ring 11 may in the first component may be performed.

Following operation 72, the process 70 moves to operation 74, wherein a braze ring 12 is secured between a first and second component. Further at operation 74, process 70 may include abutting bead portion 13 of second component (tubing member 10) against braze ring 12.

Following operation 74, process 70 moves to operation 76. At operation 76, securing ring 11 may be crimped to secure the first component to the second component. Further, operation 76 may further include operating a crimping tool to crimp securing ring 11. Operation 76 may further include engaging securing ring 11 with bead 13 to secure tubing member 10 within extrusion member 14. Operation 74 may further still include sandwiching braze ring 12 between bead 13 and step down portion 18 of bore 19 in response to crimping of securing ring 11.

Operation 76 of Process 70 may be followed by operation 78 of brazing the braze ring 12. Operation 78 of brazing the braze ring may include controlled atmosphere brazing.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A heat exchanger assembly comprising:
an extrusion member;
a tubing member;
a braze ring; and
a securing area provided in a surface of the extrusion member the securing area engaging the tubing member to secure the tubing member to the extrusion member.

2. The heat exchanger assembly of claim 1 wherein the securing area comprises a staking hole and a securing member.

3. The heat exchanger assembly of claim 2 wherein the securing member engages the tubing member to secure the tubing member to the extrusion member.

4. The heat exchanger assembly of claim 1 wherein an annular groove is provided on an upper surface of the extrusion member.

5. The heat exchanger assembly of claim 4 wherein the groove on the upper surface of the extrusion member is radially displaced from a step down portion provided within a bore of the extrusion member to form a securing ring.

6. The heat exchanger assembly of claim 5 wherein the securing ring is crimped to engage the tubing member to secure the tubing member to the extrusion member.

7. The heat exchanger assembly of claim 1 wherein a step down portion is provided within a bore of the extrusion for receiving the braze ring.

8. The heat exchanger assembly of claim 7 wherein the tubing member is provided with a bead portion to abut against the braze ring.

9. The heat exchanger assembly of claim 8 wherein the braze ring is sandwiched between the bead portion on the tubing member and the step down portion of the extrusion member.

10. The heat exchanger assembly of claim 1 wherein the extrusion member is a nonclad alloy.

11. The heat exchanger assembly of claim 1 wherein the tubing member is a nonclad alloy.

12. A method of securing two components comprising:
retaining a braze ring between a first component and a second component;
securing a surface area of the first component to the second component; and
brazing the braze ring.

13. The method of claim 12 further comprising a bead portion on the first component, abutting the bead portion against the braze ring.

14. The method of claim 13 further comprising sandwiching the braze ring between the bead portion and a step down portion in the first component.

15. The method of claim 12, wherein securing the surface area comprises performing a staking procedure.

16. The method of claim 15, wherein the staking procedure comprises forming staking holes and securing members, wherein the securing members engage the second component.

17. The method of claim 12 wherein securing the surface area comprises machining a groove to form a securing ring and crimping the securing ring to engage the second component.

18. The method of claim 12 wherein the brazing is controlled atmosphere brazing.

19. The method of claim 12 wherein the first component is a non clad alloy.

20. The method of claim 12 wherein the second component is a non clad alloy.
